(19) United States
(12) Patent Application Publication
(10) Pub. No.: US 2004/0180213 A1
(43) Pub. Date: Sep. 16, 2004

(54) Coating composition capable of absorbing uv radiation

(76) Inventors: Dominic Richard Harris, Mt Waverley (AU); Pavla Meakin, Croydon (AU); Terence William Turney, Mt Waverley (AU); Imre Lele, Kew (AU)

Correspondence Address: McDermott, Will & Emery, 600 13th Street, N.W., Washington, DC, 20005-3096, US

(21) Appl. No.: 10/475,116

(22) PCT Filed: Apr. 19, 2002
(86) PCT No.: PCT/AU02/00490

(30) Foreign Application Priority Data
Apr. 19, 2001 (AU) PR 4469
Aug. 23, 2001 (WO) PCT/AU01/01050

(51) Int. Cl. B32B 27/40

(52) U.S. Cl. 428/423.1

(57) ABSTRACT

A coating composition that is capable of absorbing UV or UV and visible light is disclosed. The coating composition includes a carrier and a pigment dispersed in the carrier. The pigment includes nanoparticles of a UV light absorber such that the coating composition is capable of absorbing UV light up to 360 nm or nanoparticles of a UV and visible light absorber such that the coating composition is capable of absorbing UV and visible light up to 550 nm, and the absorber includes an inorganic material.

### FIELD OF THE INVENTION

The present invention relates to a coating composition that can provide protection from exposure to ultra violet (“UV”) light or UV and visible light having wavelengths from less than 200 nm and up to 500 or 550 nm.

In particular, the present invention relates to a coating composition that can be applied to containers that are used for storage of products that are light sensitive. Such products include, but are not limited to, foods, beverages, and pharmaceuticals.

### BACKGROUND OF THE INVENTION

Uncoloured clear containers are known to fail to protect light sensitive contents of the containers from the deleterious effect of UV light or UV and visible light.

In the prior art, only fully opaque containers (such as metal cans and paperboard containers) and translucent containers (such as amber coloured glass or plastic containers) offer UV and visible light protection.

Fully opaque or deep amber coloured containers are less attractive than clear containers in situations where consumers wish to see and inspect the contents of the containers.

Market research indicates that transparent blue or green containers are particularly attractive to consumers because they present an image of high quality. It is commonly believed that blue or green transparent containers provide protection from UV light or UV and visible light. However, in fact, such containers provide the same low level of protection provided by uncoloured clear containers.

A particular deleterious effect of UV and visible light on beverages such as beer or wine is the generation of off-flavours called “lightstrike”. The human nose is particularly sensitive to such off-flavours and therefore the use of containers with UV and visible light protection is important for such products.

One approach to the “lightstrike” problem in beer has been the use of hops that are chemically modified so as to remove the chemical precursor of the molecules responsible for the off-flavours. However, these molecules are also the chemicals that contribute to the bitter flavour that is sought by beer drinkers. Thus, the resulting beer is considerably less attractive to many consumers.

Typically, beer products are packaged in amber or green glass containers. A comparison of the UV and visible light shielding properties of amber and green glass can be seen in FIG. 1 (absorbance) and FIG. 2 (transmission). Amber glass as shown in FIG. 1 exhibits significant absorbance over the whole of the UV and a significant part of the visible light spectrum, ie generally in the wavelength region up to 500 nm. On the other hand, green glass absorbs strongly in the region below 320 nm but less well in the region between 320-500 nm. The results shown in FIGS. 1 and 2 are significant as it is believed that light in these wavelengths is required for the production of “lightstrike” flavours.

Thus, it can be seen that traditional green glass does not prevent transmission of the damaging UV and visible light wavelengths nearly so well as amber glass, notwithstanding that green glass is used by many brewers for their products and indeed has a wide consumer acceptance.

The need to increase the UV and visible light protecting abilities of glass has been addressed in the past by the application of organic UV and visible light absorbing materials to glass surfaces. Generally, such materials are sacrificial and absorb UV and visible light and are thereby degraded. Such materials are both expensive and, because of their sacrificial action, are unsuitable for products that have long shelf lives.

It is also known that selected metal oxides can strongly absorb in the UV and visible regions of the light spectra. However, such metal oxides have lacked the clarity and the transparency to be suitable for use as additives for coatings to be applied to containers where it is important to be able to view the contents of the containers.

It is an object of the present invention to provide a coating composition that is capable providing protection from damaging wavelengths of UV light or UV and visible light.

### SUMMARY OF THE INVENTION

According to the present invention there is provided a coating composition that includes a carrier and a pigment dispersed in the carrier, and the pigment includes nanoparticles of a UV light absorber such that the coating composition is capable of absorbing a significant amount of the incident UV light up to 360 nm or nanoparticles of a UV and visible light absorber such that the coating composition is capable of absorbing a significant amount of the incident UV and visible light up to 550 nm, and the absorber includes an inorganic material.

The term “nanoparticles” is understood herein to mean that the particles are small enough to appear transparent with no haze in visible light.

In view of issues relating to accurate measurement of the size of small particles, the applicant does not wish to be limited to a definition of the term “nanoparticles” that is based on a particular size range of particles.

Nevertheless, preferred nanoparticles are particles less than 100 nm (0.1 microns) equivalent spherical diameter.

More preferably, nanoparticles include no significant concentration of particles that exceed 100 nm (as determined by Transmission Electron Microscopy) and have effective colloidal stabilisation with no aggregation, agglomeration or flocculation of individual particles, both as a liquid coating composition and as a coating of the coating composition.

More preferably, nanoparticles are particles less than 50 nm (0.05 microns) equivalent spherical diameter.

One suitable type of inorganic material of the absorber is iron oxides.

Iron oxide-based absorbers are suited particularly for forming coloured transparent coatings of the coating composition.

Iron oxide-based absorbers are also suited particularly for absorbing the UV and visible region of the light spectra.

Another, although not the only other, suitable type of inorganic material of the absorber is zinc oxides.

Zinc-oxide-based absorbers are suited particularly for forming colourless transparent coatings of the coating composition.

Zinc-oxide-based absorbers are also suited particularly for absorbing the UV region of the light spectra.

The pigment may include more than one type of absorber.

Preferably the pigment further includes nanoparticles of a pigment that provides or contributes to the colour of the coating composition.

By way of example, the pigment may include blue or green pigments or a combination of pigments that result in blue or green pigments.

More preferably the pigment further includes nanoparticles of blue or green pigments that cause the coating composition to be a transparent blue or green colour.

More preferably the pigment includes nanoparticles of yellow or red iron oxide absorber pigments and blue or green pigments that cause the coating composition surprisingly to be a transparent blue or green colour.

The combination of pale yellow or red iron oxide absorber pigments and blue or green pigments creates a coating composition having good UV and visible light absorption characteristics whilst being a transparent blue or green appearance—an attractive commercial proposition.

Preferably the carrier is capable of acting as (i) a dispersant of the pigment particles and (ii) a film former.

Preferably the carrier is a polymeric material.

The carrier may be a composite of a number of materials that have a range of characteristics.

For example, the materials may include materials that have dispersant characteristics predominantly, materials that have film-forming characteristics predominantly, and materials that have dispersant and film forming characteristics.

Preferably the film forming material is selected from the group that includes polyurethanes, polyesters, polyolefins, polyvinyls (including polyvinyl chlorides) and polyacrylics.

According to the present invention there is also provided a substrate having a coating of the above-described coating composition.

The substrate may be formed from any suitable material.

Examples of suitable materials are glass and plastics materials.

Preferably the substrate forms a wall of a container, such as a bottle, and the coating is on an outer surface of the container.

Preferably the thickness of the coating is no more than 100 microns.

More preferably the coating thickness is no more than 50 microns.

The thickness of the coating is related to the level of protection required and to the concentration of the UV light or UV and visible light (“UV/Vis”) absorber in the pigment in the coating composition. Specifically, a range of different combinations of (i) the concentration of the UV/Vis absorber and (ii) the coating thickness can provide a given level of protection.

At one extreme it is possible to have a relatively high concentration of the UV/Vis absorber and a relatively small coating thickness and at the other extreme it is possible to have a relatively low concentration of the UV/Vis absorber and a relatively large coating thickness.

This is an important point because it means that it is possible to impart desired physical attributes of the coating, such as wear resistance, scuffing resistance, cost and transparency by changing the concentration of the UV/Vis absorber and/or the coating thickness.

Depending on circumstances (such as the substrate being coated, the end use of the substrate, and the coating apparatus for applying the coating) it may be preferable to vary the concentration of the UV/Vis absorber and the coating thickness between the above-described two extremes to provide a given level of protection.

For example, for cold end coated containers, such as beer bottles it is preferred that the coating thickness be in the range of 0.1-2 microns.

More preferably the coating thickness is 0.1-1.5 microns and more preferably 0.3-1.5 microns.

It is a surprising aspect of the invention that smooth, UV and visible light absorptive blue coatings may be applied as cold end coatings at coating thicknesses of 0.3 to 1 microns.

According to the present invention there is also provided a method of forming a coating composition capable of absorbing UV light up to 360 nm or UV and visible light up to 550 nm, which method includes a step of wet milling a carrier and a pigment to form a comminuted dispersion of the pigment in the carrier, and the pigment including nanoparticles of an absorber capable of absorbing UV light or UV and visible light up to 550 nm.

It is preferred particularly that the carrier includes a dispersant in order to prevent floccs forming during the wet milling step.

Preferred dispersants include:

(a) polycarboxylate for aqueous media; and

(b) entropic (“Solsperse”) hyper-dispersants for non-aqueous media.

Preferably the wet milling step is carried out at a low solids content.

Preferably the solids content is 5-30 by weight.

More preferably the solids content is 15-25% by weight.

Preferably the wet milling step includes wet stirred media milling (bead milling) in batch, continuous passes, or continuous recirculation modes using small beads (<0.7 mm diameter) with a power input of more than 0.5 kW per litre of shell volume for a prolonged period until the required transparency is achieved.

The wet milling step may be as described in International Application no WO9717406 in the name of M J Bos Consultants Pty. Ltd.

According to the present invention there is also provided a method of forming a coating of a coating composition capable of absorbing UV and visible light up to 550 nm on a substrate, which method includes the steps of:

(a) forming the coating composition as described above; and

(b) applying the coating composition onto the substrate to form a continuous coating on the substrate.

The coating composition may be applied to the substrate by any suitable means, such as spraying or roller-coating the coating composition onto the substrate.

Preferably the method includes adding further carrier to the coating composition formed in step (a) and thereby diluting the coating composition to a required pigment volume concentration prior to applying the substrate in step (b).

Preferably the further carrier is a film forming material.

Preferably the pigment volume concentration is 25-45%

More preferably the pigment volume concentration is 30-40%.

Preferably the substrate is a wall of a container and step (b) is part of a container manufacturing method.

Preferably the container is a glass container.

Glass container manufacturing, for example glass bottle manufacturing, typically includes two stages during which coatings may be applied to the bottle surface.

A hot end coating (HEC) is applied to glass using chemical vapour deposition techniques immediately after forming a glass container when the surface temperature of the container may be 600° C. or higher. The HEC is typically a ceramic material such as tin oxide and serves both to protect the glass surface from damage and also to provide a substrate for the cold end coating.

A cold end coating (CEC) is applied after a glass container has been annealed at a surface temperature of 120-180° C. The CEC consists of an organic coating that provides the glass surface with the necessary lubricity for high speed passage through automatic inspection and filling lines. Some coatings also serve to protect the glass surface from abrasion damage and to preserve the inherent strength of the glass. Cold end coatings may be based on silicone waxes, polyethylene, polyvinyl alcohol, stearic acid, oleic acid, polyurethane, polyester, polyolefins, and polyacrylics.

The coating composition of the present invention may be applied to a glass container in a cold end stage of bottle manufacture.

Preferably the coating thickness is 0.1-1.5 microns.

Preferably the carrier of the cold end coating is the carrier of the coating composition of the invention.

In a particularly preferred form of the invention the carrier of the coating composition is a water-based thermoplastic acrylic or polyurethane or polyester material and the coating composition is applied to a container surface at the CEC stage.

Alternatively, a solvent-based thermosetting setting acrylic or polyurethane or polyester material may be used under specialised application conditions unrelated to cold end coating.

### (a) DESCRIPTION OF DRAWINGS

The present invention is described further by reference to the following Examples and the accompanying drawings.

The drawings:

FIG. 1 compares the UV/Vis shielding properties of clear, green and amber glass used in beer bottles, displayed as UV/Vis absorbance;

FIG. 2 compares the UV/Vis shielding properties of clear, green and amber glass used in beer bottles, displayed as UV/Vis transmittance;

FIG. 3 compares the UV/Vis shielding properties of (i) a coating composition (formulation A) in accordance with the invention as described in Example 1, (ii) clear glass, and (iii) amber glass used in beer bottles, displayed as UV/Vis absorbance;

FIG. 4 compares the UV/Vis absorbance of the composition used in FIG. 3 against the UV/Vis absorbance of commercial glass products;

FIGS. 5 and 6 compares the UV/Vis absorbance of a 1 microns film of coating composition (formulation B) in accordance with the invention as described in Example 1 and commercial glass products;

FIG. 7 compares the UV/Vis absorbance of a 0.5 microns film of coating composition (formulation RH503) in accordance with the invention as described in Example 4 and amber glass;

FIG. 8 compares the UV/Vis absorbance of a 0.6 microns film of coating composition (formulation RH502, RH504, RH505 blend) in accordance with the invention as described in Example 4 and amber glass; and

FIG. 9 compares the UV/Vis absorbance of a film of a ZnO-based coating composition in accordance with the invention as described in Example 5 and a control coating.

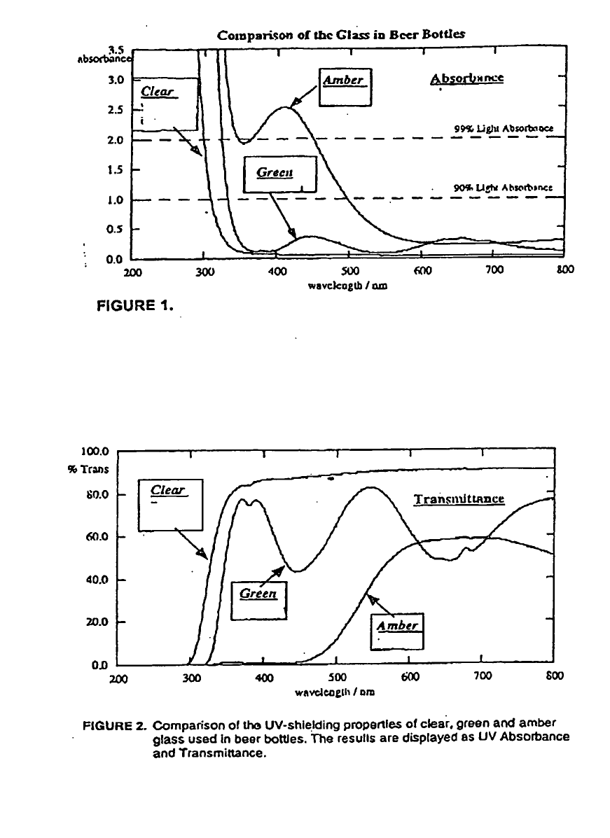

### EXAMPLES

### Example 1

Formulations A and B—in accordance with the invention.

Formulation A—based on a thermosetting acrylic carrier.

On a solid/solid basis, the coating composition included:

12% FeOOH (TOY-Pigment Yellow 42) pigment

1.3% Fe₂O₃ (TOR-Pigment Red 101) pigment

0.5% Blue 5203 pigment (Pigment Blue 15:3)

20 parts per hundred of pigment of solsperse 3000 (a hyperdispersant)

40 parts thermosetting acrylic solution

“TOY” is an iron oxide yellow pigment supplied commercially by Johnson Matthey under the product name Trans Oxide Yellow AC0500.

“TOR” is an iron oxide supplied by Johnson Matthey under the product name Trans Oxide Red AC1000.

Formulation B—based on a polyethylene emulsion as a carrier.

The coating composition was similar to formulation A, with the exception that it was (i) aqueous, (ii) included 20 parts per hundred of pigment of Orotan 731 (a polycarboxylic dispersant) pre-prepared as the ammonium salt as a replacement for the solsperse 3000; and (iii) included a commercially available polyethylene emulsion product (used as a cold end coating in glass bottle manufacture and sold under the trade name DURACOTE) as a replacement for the acrylic resin of formulation A.

Physical Characteristics of Formulations A and B.

The applicant found that nanoparticles of iron oxide pigment in formulations A and B did not flocculate and the coating compositions were a green colour.

The colour of the coating compositions was virtually indistinguishable from the traditional green glass used for beer bottles.

Performance of Formulation A

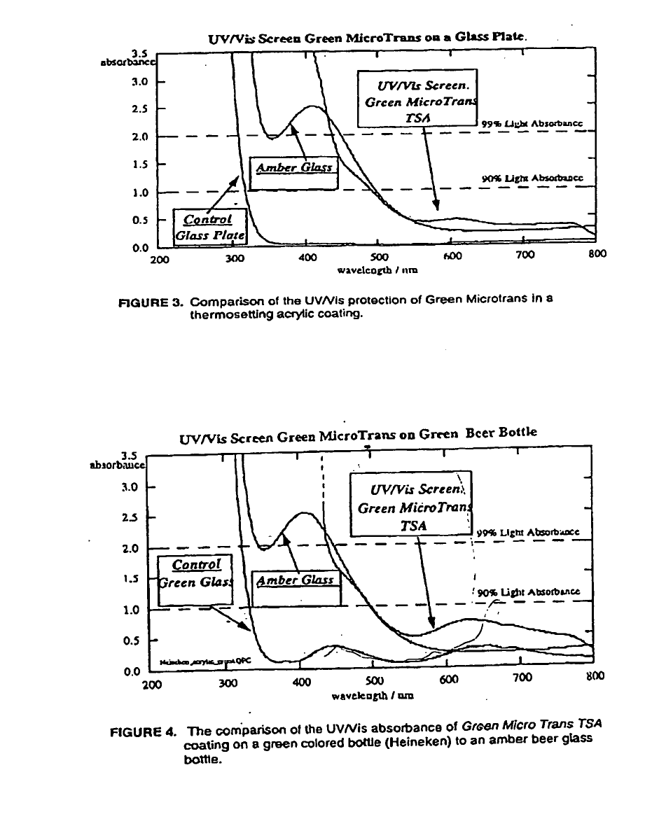

The extent to which formulation A, the coating composition based on the thermosetting acrylic carrier, could absorb UV and visible light was evaluated by forming a thin coating of 2 microns of the composition on a glass plate and comparing the UV/Vis absorbance with that of an untreated glass plate and a commercially available amber glass product used for beer bottles. The results are shown in FIG. 3.

It can be seen from FIG. 3 that the coated glass had significantly improved absorbance compared with the untreated glass and provided similar protection to the known amber glass product.

The formulation used above was applied as a coating on a green bottle. As has already been observed, the UV absorbance of green bottles falls short of the standard desired by food producers and brewers. The effect of coating the green bottle with the formulation is shown in FIG. 4.

It can be seen from FIG. 4 that the coating provided generally superior protection against UV light in the harmful wavelengths between 350 nm and 500 nm.

Performance of Formulation B

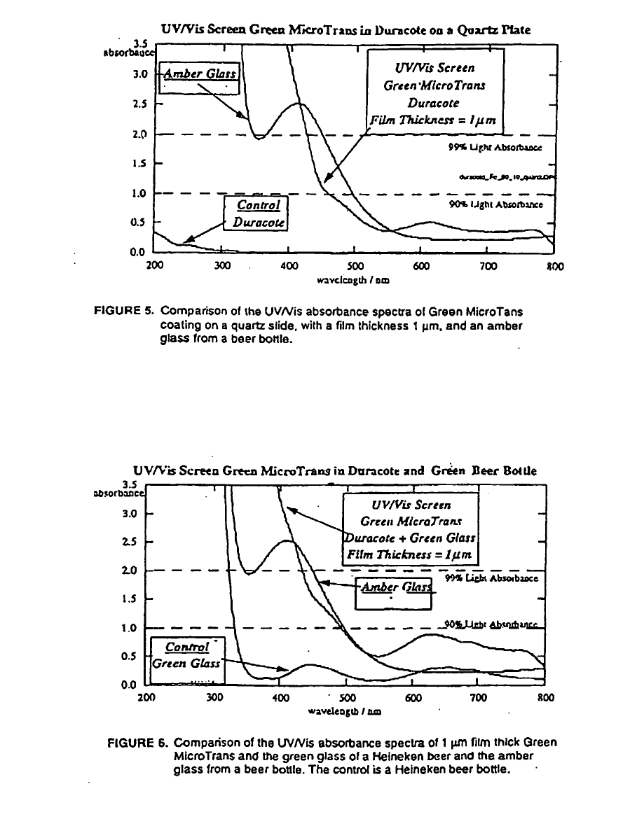

The UV/Vis absorbance of a 1 micron coating of formulation B, the composition based on a polyethylene emulsion, was measured and compared with that of a standard amber bottle. The results are shown in FIG. 5.

The absorbance of the coating on the quartz slide was comparable to that of the amber bottle. However, the results should be considered in the context that a quartz slide has no absorbance in the wavelengths measured and that the film thickness was only 1 micron.

The UV/Vis absorbance of formulation B was also compared with that of a green glass beer bottle as shown in FIG. 6. The UV/Vis protection offered by the coating formulation was very similar to, or better than, amber glass.

### Example 2

The transparent coating formulations in accordance with the invention tested in this example contained 5-100 nm diameter nanoparticles of iron oxide and other pigments dispersed in carriers having dispersant and film-forming characteristics.

Milling Procedure.

The coating formulations were formed in accordance with the following standardized procedure.

A 1 litre stainless steel vessel of 100 mm internal diameter was fitted with a water jacket for cooling. A rotor shaft carrying 4 plain, 6 mm thickness, 90 mm diameter, circular discs made of ultra high molecular weight polyethylene were placed in the vessel. The net volume of the mill was 850 ml. This net volume was charged to 85% with 0.268 kg of 0.4 to 0.7 mm diameter partially stabilized zirconia beads (47% voidage). A lid was bolted and sealed to the top of the mill with the rotor shaft passing through a hole and stirrer guide in the lid. 400 ml of each of the mill base formulations set out below were charged to the mill. The actual weight of the additions was determined according to density. For example, for a mill base formulation of density 2.2 kg/l, the amount of mill base added was 0.88 kg. The rotor was driven at a rate such that the peripheral speed of the discs was 10 m/s, ie 2100 rpm for the 90 mm diameter discs. Milling of each of the formulations, with ambient temperature water passing through the cooling jacket, was continued for at least two hours.

The above-described nano-milling is very intensive by comparison with mere dispersive milling of pigments for paint and inks. In terms of intensity, measured as litres of mill base per litre of bulk beads per hour, the milling produced 0.3 litres or less compared to 9 litres or more produced in conventional milling, with beads of several mm diameter, of pigments for ink and paint.

It was by means of this intensive milling that the coating formulations were able to achieve the clarity and the protective absorption of light that is reported below.

Formulations

As indicated above, the transparent coating formulations contained 5-100 nm diameter nanoparticles of iron oxide and other pigments dispersed in carriers having dispersant and film-forming characteristics.

Colloidal stabilisation of the 5-100 nm diameter nanoparticles and the correspondingly high surface areas (1000-50 square metres per millilitre) of the nanoparticles were necessary both:

(a) throughout the milling to prevent re-aggregation of particles and flocculation; and

(b) on blending with resins and dilution to coating to prevent flocculation and loss of protective absorbance.

At the same time, in addition to having dispersant characteristics, the carrier was also required to be film forming and mechanically and pasteurisation resistance.

The dispersants used in the formulations were:

(a) polycarboxylate dispersants for aqueous media, including a proportion of polyacrylic acid as an ammonium salt; and

(b) entropic (“Solsperse”) hyperdispersants for non-aqueous media.

The coating formulations were low in viscosity, 5 to 10 cP, and had negligible rheological yield value, ie they were Newtonian.

The coating formulations had the following compositions and characteristics.

Formulation 1—blue-green light protective cold-end coating additive—12% Fe₂O₃ PR101—8% PY124—3% CuPc-PB15:3 aq—18 pph Joncryl 61HV—10 p Dispex A40. Milled for 2.25 hr. Strong pure bottle green—clear.

Formulation 2—amber light protective coating additive—18% Fe₂O₃ PR101—4% PY124 1.5% CuPc-PB15:3 aq—18 pph Joncryl 61HV—10 pph Dispex A40. Milled for 2 hr. Dark amber—clear. The colour changes intensity less with variation in film thickness on spraying.

Formulation 3—blue-green light protective cold-end coating additive—12% Fe₂O₃ PR101—2.3% PY124—8.8% CuPc-PB15:3 aq. Milled for 2 hr. Strong blue green—very clear. The colour is more blue-green than formulation 1.

Formulation 4—increased level of Fe₂O₃ PR101 for more protection at lower thickness—09F(506) 18% Fe2O3-PR101—4% PY124 1.5% CuPc-PB15:3 aq.—18 pph Joncry 161HV—10 pph Dispex. Milled for 1.75 hr. Gold-Brown—very clear.

Formulation 5—04F(500) 12% Fe₂O₃—8% PY124—3% CuPc aq.—18 p Joncryl 61HV—10 pph Dispex. Milled for 5 hr. Strong blue green—clear.

Formulation 6—10% Fe₂O₃—12% Pigment Green—36 1% CuPc aq.—18 p Joncryl 61HV—10 pph Dispex. Milled for 3 hr. Bright green—clear. Pigment Green 36 yields a purer green than combinations of blue and yellow 03J(475).

Formulation 7—10% Fe₂O₃—14% PG36 aq.—18 pph Joncryl 61HV—10 pph Dispex. Milled for 2 hr. Bright yellow-green—clear. Pigment Green 36 yields a purer green than combinations of Blue and Yellow 03J(474).

Formulation 8—(468) 10.3% Fe₂O₃—13.7% PG36 aq.—18 p Joncryl 61HV—10 pph Dispex. Milled for 2 hr. Yellow green—clear.

Light Absorbance Evaluation of Formulations 1 to 8

The light absorbance of coating formulations 1 to 8 was tested. The test procedure and the results are discussed below.

Clear dispersions of the formulations produced by the milling procedure were diluted to 35% pigment volume concentration with resins, as is appropriate, such as polyethylene aqueous emulsion for cold-end coating or aqueous or solvent borne acrylic or solvent borne polyurethane resin.

The diluted formulations were applied to glass or clear plastic to form coatings of about 1 microns film thickness, sometimes as thin as 0.5 or 0.3 microns, yet providing the protection exceeding that of amber glass and film properties required.

Absorbance of UV and visible (Blue) light by the coatings was measured on a Varian Cary Model 1E UV-Visible Spectrometer and exceeded 2 (99%) up to 450 nm and exceeded 1 (90%) up to 500 nm for the coatings of the formulations. In other words, the absorbance exceeded the absorbance of amber glass typically used for beer bottles.

Haze of 0.5 to 1 microns thick coatings of the formulations was less than 15% as measured on the Cary Spectrophotometer.

Film thickness was measured on a Taylor Hobson Talysurf 10 Surface Profile Analyser

Pasteurisation resistance was tested by immersion in water at 65-70° C. for one hour. The results were satisfactory.

Scuff resistance and lubricity of the coatings with bottle to bottle contact were also assessed. The results were satisfactory.

### Example 3

The following coating formulation components were added to a stirred vessel in the parts by weight indicated below to form a mill base:

| | | |
|---|---|---|
| BASF Sico FR1363 PY124 | 0.78 | parts |
| BASF Heliogen Blue D7072 PB15:3 | 0.309 | parts |
| Johnson Matthey AC1000 PR101 | 1.200 | parts |
| Rhodia Joncryl 61HD 35% | 0.589 | parts |
| Ciba Dispex A40 40% | 0.343 | parts |
| Water | 6.78 | parts |
| Total | 10 | parts |

The mill base was milled, firstly pass by pass, then by recirculation from a well-stirred vessel to a 1.2 litre Drais Double Chamber Process Bead Mill.

The DCP mill may be fitted with a 0.25 mm aperture bead separation screen, but was operated without a bed separation screen, and charged with 3.7 kg of 0.4 to 0.7 mm diameter partially stabilised zirconia beads.

The rotor speed was at maximum rate and a pumping rate, using a progressing cavity of 5 to 151/min was maintained for 16 hours. At this point the mill base was clearly transparent.

The resultant coating composition was tested as a cold end coating by mixing 2 parts of the mill base and 1 part of DIC Duracote 20% polyethylene coating emulsion in an homogeniser.

The resultant coating composition was sprayed onto hot glass panels and hot glass bottles from a 130° C. oven to a dry film thickness of 1.0 micron as measured by a Talysurf Surface Profile Analyser.

“Absorbance” of the film on glass was measured on a Cary Model 1E UV-Visible Spectrophotometer in transmission mode and compared with the “absorbance” of amber glass.

Absorbance of the coating composition exceeded the absorbance of amber glass.

Absorbance of both the coating composition and amber glass exceeded the value of 1.0 (10% transmission at 500 nm) and exceeded 2.0 (1% transmission) at less that 470 nm down to 200 nm in the UV region.

### Example 4

Experimental work was carried out on 4 other iron oxide-based formulations RH502, RH503, RH504, and RH505 in accordance with the invention.

The composition of the formulations is set out below:

Formulation RH503—18% Fe₂O₃ PR101—4% PY124 1.5% CuPc, aq—18 pph Joncryl 61—10 pph Dispex A40.

Formulations RH502, Rh504, and RH505—18% Fe₂O₃ PR101—4% PY124 1.5% CuPc, aq—18 pph Joncryl 61—10 pph Dispex A40.

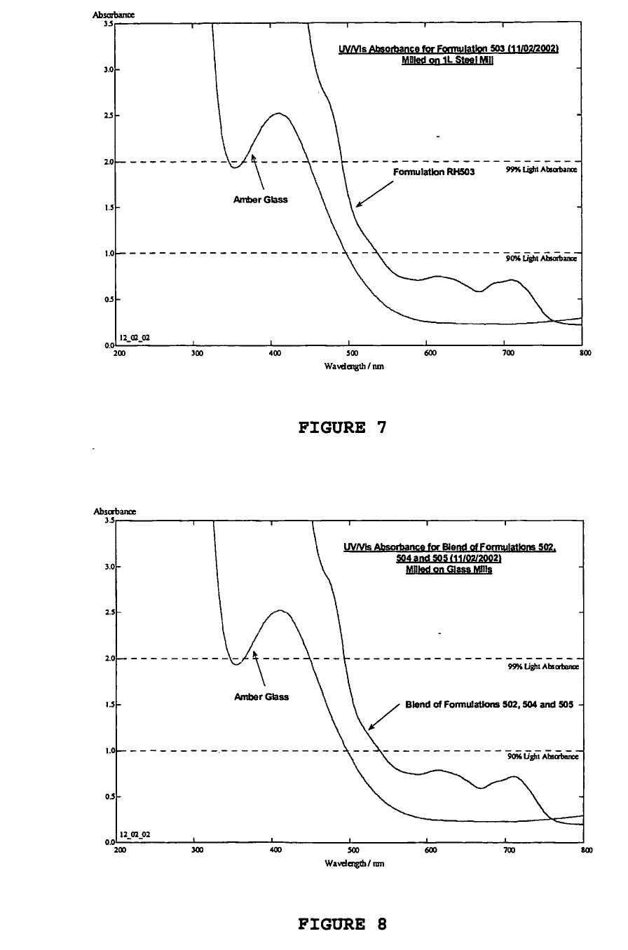

Formulation RH503 was prepared by milling in the 1 litre stainless steel mill described in Example 2 to produce a transparent coating formulation. The milling time was 6 hours. A coating of the formulation was formed and tested in accordance with the procedure described in Example 2. The coating thickness was 0.5 microns. FIG. 7 illustrates the performance of the coating.

Formulations RH502, RH504 and RH505 were prepared by milling in a glass container in a shaker mill to produce transparent coating formulations. The milling time was 48 hours. A coating of a blend of the formulations was formed and tested in accordance with the procedure described in Example 2. The coating thickness was 0.6 microns. FIG. 8 illustrates the performance of the coating.

As can be seen from FIGS. 7 and 8 the formulations achieved absorbances at or above 1.5 at a wavelength of 500 nm and had better absorbance than the amber glass standard over the wavelength range of interest.

### Example 5

Experimental work was carried out on a zinc oxide-based coating formulation in accordance with the invention.

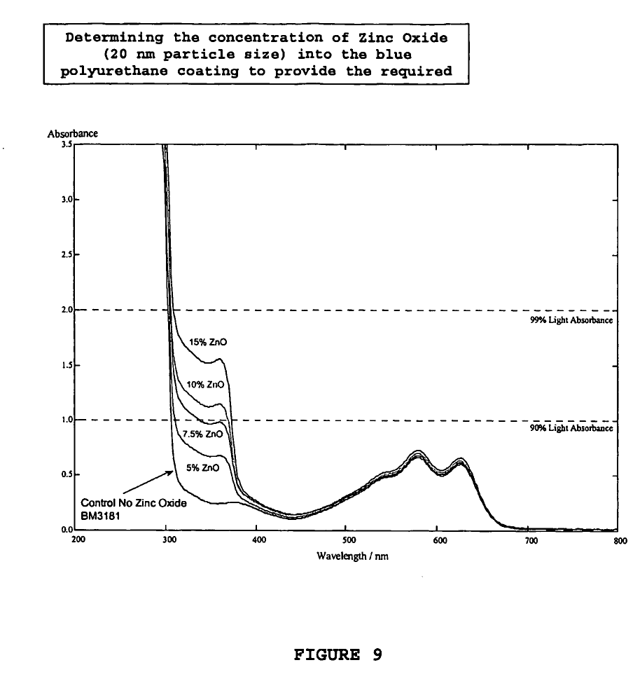

The formulation was prepared by adding 35% 20 nm ZnO(s) to 15 pph (based on solids) of Avecia Solsperse 24000 GR dispersant and 202 gms propylene glycol monomethyl ether acetate, alpha-isomer (PGMA) carrier. This formulation was milled for 46 hours to produce a transparent coating formulation. The resultant liquid was very clear, with no evidence of flocculation. The coating formulation was added to a polyurethane to give the equivalent of 5%, 7.5%, 10% and 15% dispersions of ZnO and the dispersions were used to form coatings. The results of the UV absorption characteristics of the coatings are given in FIG. 9.

It can be seen from FIG. 9 that the ZnO coating formulation had significantly better absorbance than the control coating formulation in the range of 300-400 nm, with absorbance increasing with ZnO concentration.

The invention has been described by way of example. The examples are not, however, to be taken as limiting the scope of the invention in any way.

Modifications and variations of the invention such as would be apparent to a skilled addressee are deemed to be within the scope of the invention.

1. A coating composition that includes a carrier and a pigment dispersed in the carrier, and the pigment includes nanoparticles of a UV light absorber such that the coating composition is capable of absorbing UV light up to 360 nm or nanoparticles of a UV and visible light absorber such that the coating composition is capable of absorbing UV and visible light up to 550 nm, and the absorber includes an inorganic material.

2. The coating composition defined in claim 1 wherein the nanoparticles are particles up to 100 nm (0.1 microns) diameter.

3. The coating composition defined in claim 2 wherein the nanoparticles are particles up to 100 nm (0.1 microns) diameter with no significant concentration of particles exceeding 100 nm and have effective colloidal stabilisation both as a liquid coating composition and as a coating of the coating composition.

4. The coating composition defined in claim 2 wherein the nanoparticles are particles of up to 50 nm (0.05 microns) diameter.

5. The coating composition defined in any one of the preceding claims wherein the inorganic material of the absorber is an iron oxide.

6. The coating composition defined in any one of the preceding claims wherein the inorganic material of the absorber is a zinc oxide.

7. The coating composition defined in any one of the preceding claims wherein the pigment further includes nanoparticles of a pigment that provides or contributes to the colour of the coating composition.

8. The coating composition defined in any one of the preceding claims wherein the pigment further includes nanoparticles of blue or green pigments that cause the coating composition to be a transparent blue or green colour.

9. The coating composition defined in any one of the preceding claims wherein the pigment includes nanoparticles of yellow or red iron oxide absorber pigments and blue or green pigments that cause the coating composition to be a transparent blue or green colour.

10. The coating composition defined in any one of the preceding claims wherein the carrier is capable of acting as (i) a dispersant of the pigment particles and (ii) a film former.

11. The coating composition defined in any one of the preceding claims wherein the carrier is a polymeric material.

12. The coating composition defined in any one of the preceding claims wherein the carrier is a composite of a number of materials that have a range of characteristics, including dispersant and film-forming characteristics.

13. The coating composition defined in claim 12 wherein the materials are selected from (i) materials that have dispersant characteristics predominantly, (ii) materials that have film forming characteristics predominantly, and (iii) materials that have dispersant and film forming characteristics.

14. The coating composition defined in claim 13 wherein the film forming material is selected from the group that includes polyurethanes, polyesters, polyolefins, polyvinyls (including polyvinyl chlorides) and polyacrylics.

15. A substrate having a coating of the coating composition defined in any one of the preceding claims.

16. The substrate defined in claim 15 formed from glass or plastics material.

17. The substrate defined in claim 15 or claim 16 wherein the thickness of the coating is no more than 100 microns.

18. The substrate defined in claim 15 or claim 16 wherein the thickness of the coating is no more than 50 microns.

19. A container having a coating of the coating composition defined in any one of claims 1 to 14.

20. The container defined in claim 19 formed from glass or plastics material.

21. The container defined in claim 19 or claim 20 wherein the thickness of the coating is no more than 100 micron.

22. The container defined in claim 19 or claim 20 wherein the thickness of the coating is no more than 50 micron.

23. The container defined in claim 19 wherein the thickness of the coating is 0.1-2 microns when the container is a cold end coated container, such as a cold end coated beer bottle.

24. A method of forming a coating composition capable of absorbing UV light up to 360 nm or UV and visible light up to 550 nm, which method includes a step of wet milling a carrier and a pigment to form a comminuted dispersion of the pigment in the carrier, and the pigment including nanoparticles of an absorber capable of absorbing UV light or UV and visible light up to 550 nm.

25. The method defined in claim 24 wherein the carrier includes a dispersant in order to prevent floccs forming during the wet milling step.

26. The method defined in claim 25 wherein the dispersants include:
(a) polycarboxylate for aqueous media; and
(b) entropic (“Solsperse”) hyper-dispersants for non-aqueous media.

27. The method defined in any one of claims 24 to 26 wherein the wet milling step is carried out at a low solids content.

28. The method defined in claim 27 wherein the solids content is 5-30% by weight.

29. The method defined in claim 27 wherein the solids content is 15-25% by weight.

30. The method defined in any one of claims 24 to 29 wherein the wet milling step includes wet stirred media milling in batch, continuous, or recirculation modes using small beads (<0.7 mm diameter) with a power input of more than 0.5 kW per litre of shell volume for a prolonged period until a required transparency is achieved.

31. A method of forming a coating of a coating composition capable of absorbing UV light up to 360 nm or UV and visible light up to 550 nm on a substrate, which method includes the steps of:
(a) forming the coating composition defined in any one of claims 1 to 14; and
(b) applying the coating composition onto the substrate to form a continuous coating on the substrate.

32. The method defined in claim 31 includes adding further carrier to the coating composition formed in step (a) and thereby diluting the coating composition to a required pigment volume concentration prior to applying the coating to the substrate in step (b).

33. The method defined in claim 32 wherein the further carrier is a film forming material.

34. The method defined in any one of claims 31 to 33 wherein the pigment volume concentration is 25-45%.

35. The method defined in any one of claims 31 to 34 wherein the substrate is a wall of a container and step (b) is part of a container manufacturing method.

36. The method defined in claim 35 wherein the container is a glass container.

37. The method defined in claim 35 or claim 36 wherein step (b) includes applying the coating composition onto the container in a cold end coating stage of the container manufacturing method.
